(19) United States
(12) Patent Application Publication
(10) Pub. No.: US 2009/0115726 A1
(43) Pub. Date: May 7, 2009

(54) METHOD FOR SELECTING THE SENSITIVITY OF AN INPUT DEVICE

(75) Inventors: Hans Van Zon, Waalre (NL); Steven Ferdinand Kleijer, Helmond (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/576,144

(22) PCT Filed: Sep. 19, 2005
(86) PCT No.: PCT/IB2005/053058

§ 371 Date: Dec. 30, 2008

(30) Foreign Application Priority Data
Sep. 27, 2004 (EP) 04104681.4
Oct. 22, 2004 (EP) 04105256.4

(51) Int. Cl. G06F 3/033

(52) U.S. Cl. 345/161

(57) ABSTRACT

Consistent with an example embodiment, here is a system for selecting the speed of a pointer on a display. The system comprises an analog input device arranged to generate an analog output signal (Vₒᵤₜ), the analog input device suitable to be activated during an activation time (t). A signal processing means is arranged to select, depending on the activation time (t), a conversion function (f) for converting the output signal (Vₒᵤₜ), the conversion function being different for different activation times, so that the converted output signal determined the speed of the pointer on the display.

The speed of the pointer icon on the screen is both dependent on the time, t, and dependent on the output signal, Vₒᵤₜ, of the analog input device itself, i.e. the pointer speed is a two-dimensional function f(t, Vₒᵤₜ).

The invention relates to a system where a pointer can be moved on a display by means of a pointer-controlling device.

The invention further relates to a method of operating such a system.

In electronic devices like e.g. desktops, laptops, PDA's, mobile telephones and GPS systems a pointer icon can be moved on a display by means of a joystick-like device. The software for laptop or desktop computers, typically Windows©, requires that the pointer makes an analogue movement, i.e. the pointer icon does not make jumps. Several different types of pointer-controlling devices such as a regular mouse device, a touch pad or a joystick can be externally connected to the computer. All these devices have an analog function. This holds for the joystick as well. The pressure exerted on the joystick determines in an analoguous way the rate of movement of the pointer. With such a joystick pixels on a screen can be selected by pressing softly against the joystick while a large displacement of the pointer on the screen can be established by pressing firmly.

It is a disadvantage of the known joystick that small displacements can only be achieved by gently increasing the force or the tilt of the joystick. This requires a perfect control of the finger. The slow increase of force or tilt cannot be done very fast. Therefore, the time necessary to displace the pointer icon over only a small part of the screen (such as individual pixels or menu items) is typically long. Often also this process has to be repeated more than once because the required target (pixel, menu-item) has not been accessed correctly.

It is an object of the invention, inter alia, to provide an improved system that has more functionality.

According to a first aspect, the invention provides a system for selecting the speed of a pointer on a display, the system comprising:

an analog input device (joystick) arranged to generate an analog output signal, the analog input device suitable to be activated during an activation time,

signal processing means arranged to select, depending on the activation time, a conversion function for converting the output signal, the conversion function being different for different activation times, so that the converted output signal determines the speed of the pointer on the display.

The invention is based on the insight that the pointer speed can be selected by making the sensitivity, which exists between the output signal of the input device and the pointer speed, dependent on the time that the analog input device (such as a joystick) is accessed. The time the input device is accessed or is in operation, is called the activation time. The conversion function depends on the activation time. Depending on the elapsed activation time, the conversion function is changed. So during use of the input device, the conversion function is adapted. This time dependency can be a discrete or an analog dependency. In the discrete case, there are several time intervals in which different sensitivities exist. In the analog case, the sensitivity changes continuously with the elapsed time (acceleration).

Both analog and switch behaviour can be obtained with a single analog input device such as a joystick. The behaviour is dependent on the time that the analog input device (such as a joystick) is used. Typically, for short times (e.g. less than several hundred milliseconds) the joystick behaves like a switch while for larger times the joystick is purely an analog device.

The signal processing means may be arranged to set a trigger time. The activation time of the input device may be determined with a timer. The measured activation time is smaller or longer than the trigger time. For an activation time shorter than the trigger time a certain conversion function is selected by the signal processing means. For an activation time longer than the trigger time, a different conversion function is selected.

By selecting different conversion functions, different sensitivity modes for the pointer on the display are selected.

The conversion function f may be any suitable function, such as an exponentional, linear or logarithmic function. The output signal of the analog input device may be used as a parameter in the conversion function.

Preferably the conversion function is an exponentional function. The conversion function f may be chosen so that the output voltage (Vout) of the analog input signal is a parameter in an exponent, so f=A(t)exp(B(t)*Vout).

This means that the conversion function changes as a function of time because the sensitivity B(t) changes as a function of time. When the input device is held in a certain position (so does not change in time) the output voltage Vout is constant. Because the sensitivity B(t) may for instance increase slowly in time, the pointer speed will increase in time. So the increase of the sensitivity B(t) as a function of time makes it possible to accelerate the pointer on the display.

In an advantageous embodiment the analog input device is a magnetic input device, such a joystick which operation is based on a magnetic principle.

The magnetic input device may comprise a sensor arrangement. The sensor arrangement comprises a field detector for detecting a component of a magnetic field in a plane of the field detector; and a movable object for, in response to a movement, changing at least a part of the component of the magnetic field in the plane of the field detector. The field detector comprises at least one magnetic field-dependent element. Such a field-dependent element might comprise an anisotropic magneto-resistive material (for example an NiFe-alloy) or a magneto-resistive material (for example a giant or tunnel magneto resistance), without excluding further materials.

The signal processing means may be a microcontroller. The advantage of using a micro-controller is that it can be programmed to carry out any desired type of I/O signal processing including comparing to a threshold, amplifying, filtering, or compensating for errors for example.

The setting of a trigger time, the implementation of different conversion functions and the amplification all can be done with the micro-controller. This functionality can be implemented in software, but it is also possible to implement it in the hardware by means of an electronic integrated circuit or discrete electrical components.

The chip with the magnetic sensor arrangement (of the magnetic input device), can be on the same chip as signal processing circuitry or placed close to another signal processing chip, e.g. in the same package by wire bonds (System-In-Package).=. The short distance between the chips can reduce the influence of noise

In an advantageous embodiment, the trigger time is smaller than 1 sec. The actual trigger time is chosen such that the pointer clearly shows a different behaviour for very small times, while on the other hand the delay time for going to the ‘normal’ behaviour of the pointer is hardly noticeable. If the time is too short, the different pointer behaviour can not be observed; for too long trigger times, the delay time really becomes noticeable. A time of around 200 msec works quite well in practice.

As already mentioned, it is advantageous when the conversion function is an exponential function. The pointer speed on the display can be switched in several modes. For example three different pointer speeds can be obtained. A slow pointer speed in the order of a few pixels per second is advantageous to access individual pixels on the screen, e.g. for editing and drawing purposes. A medium pointer speed in the order of a few tens of pixels per second is advantageous to select items from a menu list. For globally selecting a certain area on the screen a large pixel speed in the order of several hundreds of pixels per second may be obtained.

Typically an analog joystick has an output signal which varies (roughly linearly) with the tilt of the joystick or the pressure exerted on the joystick. In order to achieve the different pointer speeds mentioned above, preferably a more or less exponential relationship may exist between the joystick output and the pixel speed on the screen in order to cover all the required pointer speeds. This makes the joystick very sensitive.

It is a further object of the invention to provide an easier method of operating an input-device controlled pointer for a user.

According to a second aspect of the invention, the method of operating a system for selecting the speed of a pointer on a display comprises the steps of:

Activate an input device during an activation time, thereby generating an output signal,

Select a conversion function for converting the output signal, the conversion function being dependent on the elapsed activation time,

Determine the elapsed activation time,

Adapt the conversion function based on the elapsed activation time, Convert the output signal with the adapted conversion function.

When a person starts to use the input device, he will bring the input device from a rest position into an operation position. When the input device is taken out of the rest position, the time of activation starts running. Immediately a conversion function is selected. The conversion function is adapted based on the elapsed time the input device is activated (being similar to the time of operation). Thus during use of the input device (such as a joystick), the conversion function is adapted. The analog output signal is converted with the adapted conversion function, resulting in an converted output signal. The output signal is a measure for the speed of the pointer on the display.

A trigger time may be set (e.g programmed in the software of a micro-controller) for determining whether the elapsed activation time is shorter or longer than the trigger time. In case there is only one trigger level, there are only two conversion functions, One conversion function for the activation time being shorter than the trigger time, and the other conversion function for the activation time being longer than the trigger time.

Preferably the trigger time is smaller than 1 sec, so that a person does not have to wait long before a desired sensitivity range of the pointer speed is selected.

In an advantageous mode of operation, low pointer speeds can be accessed by ticking or patting the joystick.

Any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

These and other aspects of the invention will be apparent from and elucidated with reference to the embodiments(s) described hereinafter.

The invention is further explained, by way of example and with reference to the accompanying drawing wherein:

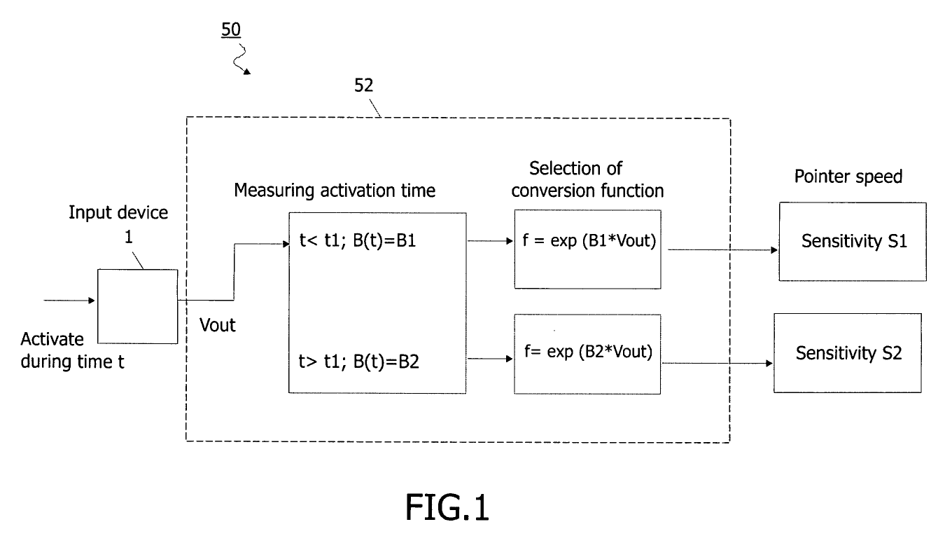

FIG. 1 is a schematic diagram of a system for selecting the speed of a pointer on a display according to the invention;

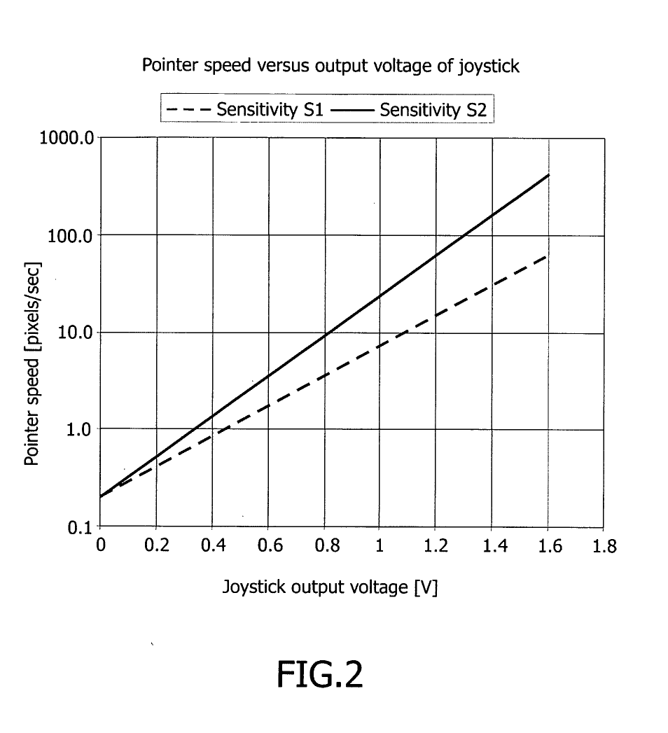

FIG. 2 shows a typical exponential relationship between the output of the analog input device (in this case Volts) and the pointer speed in pixels per second. Dependent on the time elapsed since the joystick was pushed out of its center, selectivity S₁ (t<0.2 sec) or S₂ (t>=0.2 sec) is active.

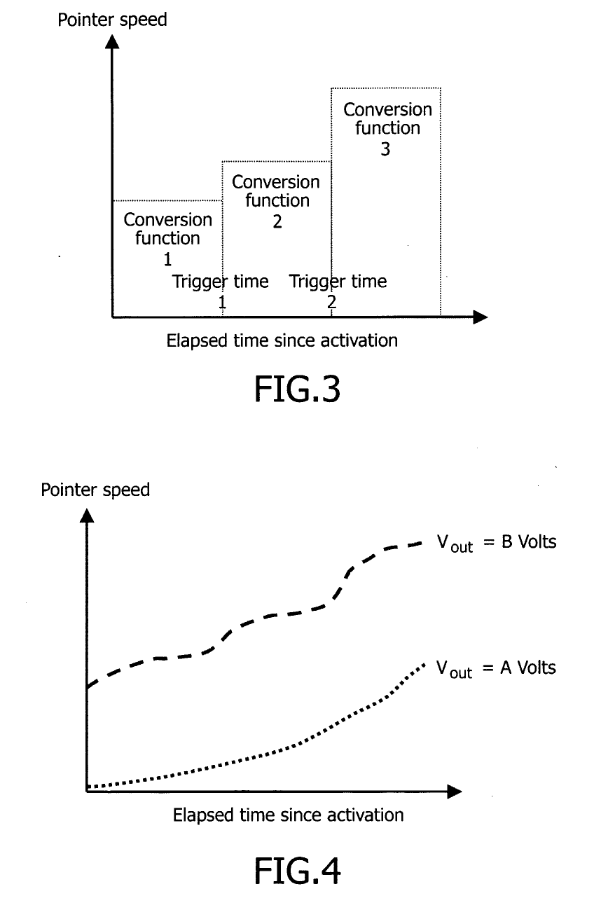

FIG. 3 shows how the pointer speed may change as a function of the elapsed time since activation of the pointer. The analog output of the joystick is kept constant. For the determination of the pointer speed, different conversion algorithms may be used.

FIG. 4 shows an example of a two-dimensional function for the pointer speed. The parameters for the function are the elapsed time since activation and the analog output of the joystick.

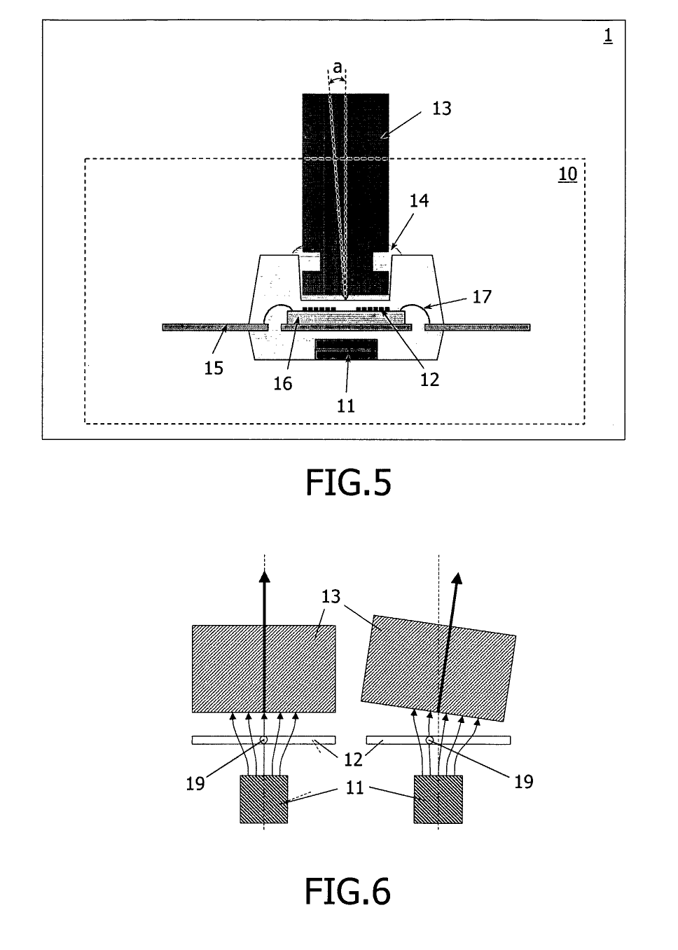

FIG. 5 is a diagram of a magnetic input device comprising a sensor arrangement shown in cross section;

FIG. 6 is a diagram illustrating a performance of the sensor arrangement;

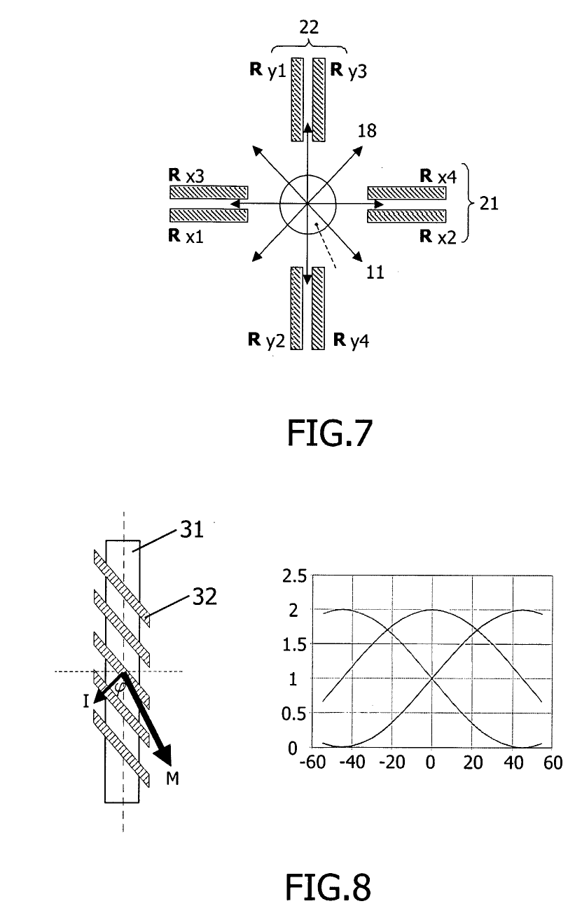

FIG. 7 shows two Wheatstone bridges for detecting radial field components in the X-direction and the Y-direction, each comprising field-dependent elements;

FIG. 8 shows a field-dependent element comprising an anisotropic magneto-resistive strip on which barberpole strips have been mounted, and a response characteristic;

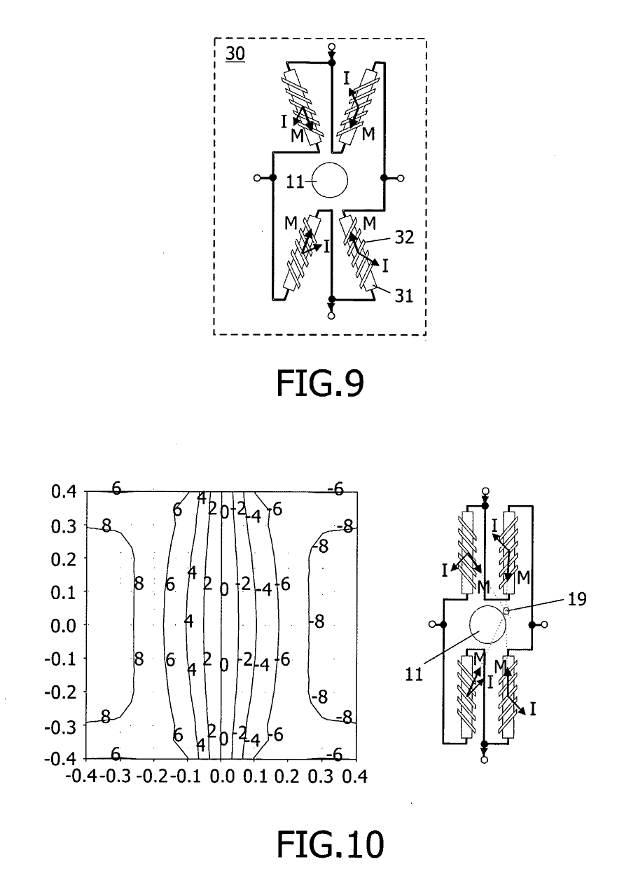

FIG. 9 shows a Wheatstone bridge comprising anisotropic magneto-resistive strips on which barberpole strips have been mounted;

FIG. 10 shows a first configuration of a Wheatstone bridge comprising anisotropic magneto-resistive strips on which barberpole strips have been mounted, and an output voltage as a function of a position of a center of a radial field component;

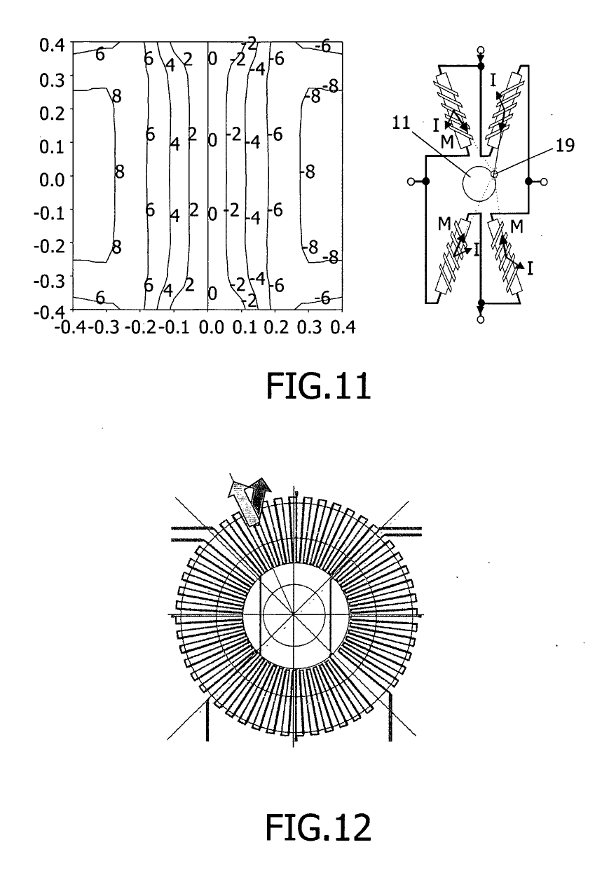

FIG. 11 shows a second configuration of a Wheatstone bridge comprising anisotropic magneto-resistive strips on which barberpole strips have been mounted which shows an improved independency between X movements and Y movements, and an output voltage as a function of a position of a center of a radial field component; and

FIG. 12 shows a sensor arrangement with parallel anisotropic magneto-resistive strips to increase the total resistance and having improved characteristics.

The system according to the invention may be used in portable PCs, laptops, or small handheld electronic devices such as mobile telephones, PDAs, digital cameras or GPS devices.

The system 50 according to the invention is schematically shown in FIG. 1. The system 50 for selecting the speed of a pointer on a display comprises an analog input device 1 arranged to generate an analog output signal Vout. The analog input device 1 may be a joystick-like device. In FIG. 3-FIG. 10 several advantageous embodiments are disclosed of a magnetic input device.

The analog input device 1 is suitable to be activated during an activation time t. The activation time t is the time that a person touches or exerts a pressure on the input device. Depending on the activation time t, there is a signal processing means 52 arranged to select a conversion function f for converting the output signal (Vout). For example, the conversion function can be an exponentional function f=A(t)exp(B(t)*Vout). When the joystick is moved, the output voltage Vout is a function of time (Vout(t)).

When the input device is held in a certain position (so does not change in time) the output voltage Vout is constant.

The conversion function may change as a function of time because the sensitivity B(t) changes as a function of time. Because the sensitivity B(t) may for instance increase slowly in time, the pointer speed may change (for instance increase) in time. So the increase of the sensitivity B(t) as a function of time makes it possible to accelerate the pointer on the display.

In this embodiment the signal processing means 52 is a micro-controller. A trigger time t1 is set and the desired conversion function f is programmed in the software of the micro-controller. For different activation times t, the conversion function is different. In this example of FIG. 1, the conversion function is f1=exp(B1*Vout) for an activation time shorter than a trigger time t1, and the conversion function is f2=exp(B2×Vout) for an activation time longer than the trigger time t1 (So for t<t1 B(t)=B1 and for t>t1 B(t)=B2). The speed of the pointer is determined by the converted output signal. In this example two sensitivities S1 and S2 for movement of the pointer are selected. By setting more trigger times and defining more conversion functions it will be understood that several sensitivities (S1, S2, . . . Sn) can be selected. By defining more time intervals which become very short, in the limit a continuous function B(t) is obtained.

A discrete case with only two time intervals, t_{A} and t_{B}, will be described to further illustrate the invention. In this case the two time intervals are separated by a time trigger level, t₁. The time trigger level is a predefined time. A practical value could e.g. be t₁=200 msec. When the joystick is at its center position, the time is set to zero. As soon as the joystick is pushed outside its center position, a timer counter starts to increase. As long as the elapsed time did not yet reach the time trigger level t₁, the speed of the pointer icon depends on the joystick output level by means of a certain sensitivity S₁. As soon as the elapsed time has become equal or larger than the time trigger level, the speed of the pointer is controlled by a different (typically larger) sensitivity S₂ to the output of the joystick (see FIG. 2). The effect of this software implementation is that the pointer icon on the screen can be quickly moved over a short distance by ‘ticking’ or ‘patting’ against the joystick. Since the pointer speed is still related to the amount of tilt or pressure on the joystick (but now with a lower sensitivity S₁), the pointer displacement is dependent on the amount of ‘ticking’. Typically the sensitivity S₁ is chosen such that with the maximum tilt or pressure on the joystick, the displacement within 200 msec is about the distance between two menu items.

| | |
|---|---|
| t < 200 msec | Access to individual pixels and menu-items |
| t > 200 msec | Access to individual pixels, menu-items and global areas |

FIG. 3 shows in another example how the pointer speed may change as a function of the elapsed time since activation of the pointer. The analog output of the joystick is kept constant. For the determination of the pointer speed, different conversion algorithms may be used.

FIG. 4 shows an example of a two-dimensional function for the pointer speed. The parameters for the function are the elapsed time since activation and the analog output of the joystick.

The speed of the pointer icon on the screen is both dependent on the time, t, and dependent on the output signal, Vout, of the analog joystick itself, i.e. the pointer speed is a two-dimensional function ƒ(t, Vout). This two-dimensional function is optimized such that a good response between the handling of the joystick and the pointer icon is obtained. One example is given, but many more combinations of t and o are of course possible to obtain a good result.

In FIG. 5 an embodiment of an input device in the form of a magnetic joystick is shown. The magnetic joystick comprises a sensor arrangement 10. The sensor arrangement 10 comprises a field generator 11 for generating a field, such as for example a magnet for generating a magnetic field. The sensor arrangement 10 further comprises a field detector 12 for detecting a component 18 (as shown in FIG. 7) of the magnetic field, and a movable object 13 such as a movable field conductor such as a joy stick for, in response to a movement, changing at least a part of the component 18. This changing for example comprises the shifting of a center 19 (as shown in FIG. 6). The component 18 for example comprises a direction.

The field generator 11 such as a permanent magnet and the movable object 13 such as a ferrite stick are for example integrated in a chip plus a package. The package is modified in such a way that the movable object 13 can be mounted in a blind hole in the package with flexible glue 14, an O-ring or any other mechanical spring. In this way the chip in the package remains protected against moist, dirt, scratches as if it were a normal package. In addition normal reflow soldering processes remain possible. In this embodiment the chip with the field detector 12 is placed close to a signal-processing chip (with for example a micro controller) in one package. The short distance between the chips reduces the influence of noise. Another advantage of using a micro-controller is that it can be programmed for the type of I/O signal, filtering, a threshold, amplification factors or even the function of some of the package leads. The field detector 12 is mounted on a substrate 16, which is coupled via wirebonds to a leadframe 15.

The sensor arrangement 10 shown in FIG. 6 with the movable object 13 comprises a pivoting point located between a center of the movable object 13 and an end of the movable object 13 located closest to the field detector 12. Preferably, this pivoting point substantially coincides with this end of the movable object 13 located closest to the field detector 12. By pivoting the movable object 13, the center 19 of the component 18 (as shown in FIG. 7) is shifted, which is detected by the field detector 12. Such a field detector 12 comprises, e.g., two Wheatstone bridges shown in FIG. 7.

The Wheatstone bridges 21 and 22 in FIG. 7 detect components 18 in the X-direction and the Y-direction. The X-direction and the Y-direction are, for example, substantially perpendicular to each other. A first one of the Wheatstone bridges 21 and 22 detects a first part of the component 18, and a second one of the Wheatstone bridges 21 and 22 detects a second part of the component 18. Each of the bridges 21 and 22 comprises one or more field-dependent elements such as magnetic field-dependent resistors, which are shown in greater detail in FIG. 8. Their resistance values are aimed to be in the kiloOhm range in order to limit power consumption. Such a resistance value is altered if a magnetic field is applied to the resistor due to the use of so-called anisotropic magneto-resistive materials (e.g., an NiFe-alloy). Typically the resistance value change of such a resistor under the influence of the magnetic field is about 2% in practical circumstances. Other magneto-resistive materials exist such as giant magneto resistive and tunnel magneto resistive materials, which give a much larger change in the resistance value. Basically the field detector 12 could also be made with these materials. However the great advantage of using anisotropic magneto-resistive materials lies in the simplicity of the material itself (a single layer of an NiFe-alloy compared to a complicated multi-layer stack in case of the other materials) and in the ease with which the response characteristic (e.g., resistance value versus magnetic field) can be altered. In the case of other materials the response characteristic has to be manipulated by means of setting and fixing magnetization directions in the stack, whereas in the case of anisotropic magneto-resistive materials the response characteristic can be set merely by forcing the electrical current through the field-dependent elements in a required direction. This can be done by using the proper layout.

In an X-Y field, detector-independent signals for the movement in the X-direction and the Y-direction have to be generated. For each direction (X, Y) a Wheatstone bridge configuration is used consisting of four resistors made of anisotropic magneto-resistive materials. These two Wheatstone bridges 21 and 22 are placed in a static radial magnetic field. The field is generated by a permanent magnet or a magnetized piece of material such as ferrite which in size is small compared to the total layout of the sensor. Another possibility is to generate the magnetic field by means of a coil or single conductor carrying an electrical current. In the proposed configuration the anisotropic magneto-resistive materials are deposited and patterned on an Si/SiO₂ substrate. The permanent magnet is positioned beneath the Si/SiO₂ substrate. The two Wheatstone bridges 21 and 22 for the X- and Y-direction are visible where each bridge consists of four resistors numbered Rₓ₁ to Rₓ₄ and R_{y1} to R_{y4}. Both bridges are positioned under substantially 90 degrees with respect to each other. Bridge Y, which lies along the Y-direction, is sensitive to a change in magnetic field in the X-direction (e.g., caused by the movable field conductor which is positioned above the field detector), whereas bridge X is sensitive to a change in magnetic field in the Y-direction.

At the center of the four resistors of a Wheatstone bridge 21,22 the permanent magnet is placed. The size of the permanent magnet is small compared to the total dimensions of the field detector 12. Under these circumstances the permanent magnet generates a radially oriented magnetic field in the plane of the field detector 12. The center of the pattern coincides with the center of the four resistors. When the resistors are also placed in a radial configuration, the in-plane magnetic field lines will be parallel to the length directions of the resistors. The described configuration is actually the magnetic field configuration of the field detector 12 in rest, i.e., the magnetic field lines are not disturbed by the presence of, e.g., the movable field conductor. The strength of the magnetic field is preferably large enough to fully saturate the resistors, which means that the magnetization direction in the resistor strips is parallel to the radial field lines. Such a strong field has the advantage that the field detector 12 becomes more insensitive to the influence of stray-fields present around the sensor arrangement 10 (e.g., due to currents flowing in the neighborhood of the sensor arrangement).

The field-dependent element 31 shown in FIG. 6 comprises a resistor in the form of an anisotropic magneto-resistive strip or AMR strip on which barberpole strips 32 have been mounted. In FIG. 6, a response characteristic of the field-dependent element 31 is shown (AMR ratio in % versus an angle of magnetization for three current angles −45, 0 and +45 degrees). In an anisotropic magneto-resistive material resistor the resistance value is determined by the angle between the magnetization in the magnetic layer and the current which flows in this magnetic layer. The resistance can be expressed by the equation R=R₀+ΔR cos²φ where R₀ is the base resistance value of the resistor, ΔR is the maximum change in resistance possible and φ is the angle between the in-plane magnetization M and the in-plane current I. The resistor is not sensitive to magnetic fields perpendicular to the plane. The direction of the current is set by means of the electrical layout of the circuit. For these field detectors 12 a barberpole construction is often used to set the direction of the current. Such a barberpole construction consists of thick metallic stripes 32 deposited on top of the AMR strip. Because the barberpole strips 32 are electrically highly conductive, the current will mainly flow perpendicular between the barberpole strips 32. Therefore the direction of the current can be set by choosing the right angle of the barberpole strips 32 with respect to the length direction of the AMR strip and is fully determined by the lithographical design of this configuration.

Without an external magnetic field, the magnetization direction in the AMR strip is determined by the shape of the AMR strip (shape anisotropy) and the crystalline anisotropy axis of the NiFe-alloy itself. The direction of the crystalline anisotropy axis can be set by depositing the NiFe-alloy in a magnetic field. Normally the direction of the crystalline anisotropy is chosen parallel to the length direction of the AMR strip. However, sometimes this is not possible in case the AMR strips have for example two (or more) directions. In case of two strip directions the crystalline anisotropy axis can be set under an angle of substantially 45 degrees with respect to the AMR strips to create some form of symmetry but if more directions are present this is hardly possible.

If the width of the AMR strips is reduced compared to the length, the shape anisotropy starts to dominate and the magnetization will be forced parallel to the length direction of the AMR strips in the absence of an external magnetic field. If also barberpole strips 32 are absent, the current through the magnetic layer is parallel to the magnetization and the AMR strip has a high resistance value equal to R₀+ΔR (φ=0). A small change in the magnetization direction hardly influences the resistance due to the shape of the cos²φ-function. Actually the sensitivity around zero field is zero. This can be improved by the use of the barberpole strips 32 that change the direction of the current. Normally the barberpole strips 32 are set under an angle of (+ or −) 45 degrees with respect to the length direction of the AMR strip. Therefore the angle between the current flowing through the field detector 12 and the magnetization will also be (+ or −) 45 degrees. If the direction of the magnetization with respect to the axis of the AMR strip is changed due to a change in the magnetic field, the angle between the current and the magnetization changes and accordingly the resistance value of the AMR strip. In FIG. 8 the response characteristic of the AMR strip is shown as a function of the angle of the magnetization with respect to the length axis of the AMR strip for three different directions of the current. For current directions of (+ or −) 45 degrees the response characteristic shows a linear behavior around 0 degrees. The direction of the barberpole strips 32 determines the shape of the response characteristic. barberpole strips 32 set under −45 degrees will show a mirrored response characteristic. When constructing a complete Wheatstone bridge, the directions of the barberpole strips 32 on the various resistors should be such that the Wheatstone bridge shows a maximum sensitivity. FIG. 7 shows such a configuration.

Referring to FIGS. 9-11, when the movable object 13 is in its rest position, the magnetizations in the resistors show a pattern according to the in-plane radial magnetic field lines of the permanent magnet. Therefore the magnetizations are either pointing to the center of the permanent magnet or pointing to the outward side of the pointing device sensor. For all AMR strips the angle between the currents and the magnetizations is (+ or −) 45 degrees and all response characteristics are in their central point. By means of a magnetically conductive stick placed above the center of the permanent magnet, the radial magnetic field can be influenced. In the proposed sensor arrangement 10 the field detector 12 is placed between the permanent magnet and the movable field conductor or pointing device. The distance between the permanent magnet and the field detector 12 and the distance between the field detector 12 and the pointing device can be optimized. The actual function of the stick is to change the position of the center 19 of the radial field while maintaining the strength of the magnetic field. FIG. 6 shows the function of the magnetically conductive stick. This can be done for example by changing the angular position of the stick. The design of the stick is such that the bottom part does not change its lateral position but only the angle with respect to the field detector surface.

The net result of the change in the angular position of the stick is the change in position of the center 19 of the radial magnetic field as indicated by the small circle in FIG. 6. This change alters the directions of all magnetic moments in the AMR strips thereby changing the resistance values and thus the output signals of the Wheatstone bridge. This is shown in FIG. 10. FIG. 10 also shows the result of a calculation of the output signal of the Wheatstone bridge as a function of the position of the center of the radial field (output ratio in mV/V versus position in mm). In this calculation it is assumed that the various magnetizations are in the direction of the radial field at the position of the field detector 12. This assumption is correct if large magnetic fields are used. As an example Wheatstone bridge Y is considered which is sensitive to a position change in the X-direction. Although it is desired that the output is completely independent of the movement of the stick in the Y-direction, it can be seen that it still is slightly influenced by such a movement. However this can be improved by choosing a different configuration of the AMR strips as is shown in FIG. 9. In this case the AMR strips are set under an angle somewhere between substantially 0 and substantially 45 degrees with respect to the X- and Y-axis, preferably between substantially 20 and substantially 30 degrees with respect to the X- and Y-axis. The corresponding output characteristic is also shown in FIG. 11 (output ratio in mV/V versus position in mm). It is clear that an improvement with respect to the original output characteristic has been obtained. Dependent on the required resistance of the Wheatstone bridge, the total resistance of a bridge element 31 can be increased by placing several line elements in series. In that case all the line segments are positioned in such a way that the axes of the line segments pass through the center of the permanent magnet, i.e., all line segments show a radial pattern.

FIG. 12 shows a sensor arrangement with anisotropic magneto-resistive strips to increase the total resistance and having improved characteristics. This field detector comprises a meander system. This increases the resistance value of the field detector and reduces power consumption. Preferably, the meander system comprises eight meanders, each meander covering a segment of a circle. Such a meander system with eight meanders provides an optimal independence between X-movements and Y movements. Each meander then covers about 45 degrees of a circle, so the average of a segment corresponds with about 22.5 degrees, which is again between 20 and 30 degrees.

The sensor arrangement 12 has a more efficient configuration. This configuration results in and/or comes from a smaller field generator 11, a more efficient use of the field by the field detector 12, a movement of the movable object 13 being better detectable, a reduced sensitivity to disturbing fields, lower costs, more linearity, etc.

Alternatively, the movable object 13 may comprise a field generator. For example one or more relative sizes and/or one or more field detectors and/or one or more configurations may become the subject of one or more divisional applications without being limited to the saturated field-dependent elements.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. System for selecting the speed of a pointer on a display, the system comprising:
an analog input device arranged to generate an analog output signal, (Vₒᵤₜ), the analog input device suitable to be activated during an activation time (t),
signal processing means arranged to select, depending on the activation time (t), a conversion function (f) for converting the output signal, the conversion function being different for different activation times, so that the converted output signal determines the speed of the pointer on the display.

2. The system of claim 1, wherein the signal processing means are arranged to set a trigger time (t₁), to determine whether the activation time (t) is above or below the trigger time (t₁), and to select the conversion function (f) corresponding to a time period below or above the trigger time.

3. System as claimed in claim 1, wherein the input device is a magnetic input device.

4. System as claimed in claim 3, wherein the magnetic input device comprises a sensor arrangement having a field detector for detecting a component of a magnetic field in a plane of the field detector and a movable object for, in response to a movement, changing at least a part of the component of the magnetic field in the plane of the field detector.

5. System as claimed in claim 1, wherein the signal processing means is a microcontroller.

6. System as claimed in claim 1, where the signal processing means is embodied in hardware.

7. System as claimed in claim 2, wherein the trigger time (t₁) is smaller than 1 sec.

8. System as claimed in claim 1, wherein the conversion function (f) is an exponential function.

9. Method of operating a system for selecting the speed of a pointer on a display, the method comprising the steps of:
activating an input device during an activation time (t), thereby generating an output signal (Vₒᵤₜ)
selecting a conversion function for converting the output signal, the conversion function being dependent on the elapsed activation time (t),
determining the elapsed activation time (t),
adapting the conversion function based on the elapsed activation time (t), and
converting the output signal with the adapted conversion function.

10. Method as claimed in claim 9, wherein a trigger time (t₁) is set to determine whether the activation time (t) is below or above said trigger time (t₁), and a conversion function (f) is selected corresponding to a time interval below or above the trigger time (t).

11. Method as claimed in claim 10, wherein the trigger time (t₁) is smaller than 1 sec.

12. Method claimed in claims 9 10 or 11, method as claimed in claim 9, wherein the input device is activated by ticking or patting.
